(19) United States
(12) Patent Application Publication
(10) Pub. No.: US 2014/0354550 A1
(43) Pub. Date: Dec. 4, 2014

(54) RECEIVING CONTEXTUAL INFORMATION FROM KEYBOARDS

(71) Applicant: Microsoft Corporation, Redmond, WA (US)

(72) Inventors: Rouella J. Mendonca, Redmond, WA (US); Alex G. Snitkovskiy, Renton, WA (US); Hirofumi Yamamoto, Bellevue, WA (US); Randall E. Aull, Kenmore, WA (US); Nathan C. Sherman, Sammamish, WA (US); James C. Marshall, Redmond, WA (US); Scott Mail, Seattle, WA (US)

(73) Assignee: Microsoft Corporation, Redmond, WA (US)

(21) Appl. No.: 14/020,077

(22) Filed: Sep. 6, 2013

Related U.S. Application Data
(60) Provisional application No. 61/828,609, filed on May 29, 2013.

(51) Int. Cl. G06F 3/02

(52) U.S. Cl. CPC G06F 3/02
USPC 345/168

(57) ABSTRACT

Disclosed are techniques and systems for obtaining contextual information at least in part from a keyboard, to improve typing efficiencies and user experience. The contextual information may include keyboard attributes, typing metadata, user actions, and the like. The keyboard may be configured to detect an input event at the keyboard. A human interface device (HID) stack is configured to receive the contextual information, and a keyboard manager is configured to determine an output based at least in part on the input event and the contextual information. The output may be a most probable function (non-text-based output), or character or word (text-based output) that can be suggested or used to auto-correct application data. In some embodiments, the user action received in the contextual information may be translated to a gesture to manipulate application data.

### CROSS REFERENCE TO RELATED APPLICATIONS

This patent application claims the benefit of U.S. Provisional Patent Application Ser. No. 61/828,609 filed May 29, 2013, entitled “RECEIVING CONTEXTUAL INFORMATION FROM KEYBOARDS”, which is hereby incorporated in its entirety by reference.

### BACKGROUND

Keyboards are popular input mechanisms for providing input to a variety of computing devices. Notwithstanding the development of various alternative human input technologies, such as touchscreens and voice recognition, to name only two, keyboards remain the most commonly used device for human input to computing devices.

As computer technology has advanced, so has the associated keyboard hardware technology. Particularly, as computing devices have gone from large, clunky devices, to relatively small, portable devices, new hardware technologies have been developed for keyboards to meet the design constraints imposed by these small form factor computing devices. For example, pressure sensitive keyboards were developed to allow for thinner and more portable keyboard designs by virtue of eliminating the need for mechanically movable, or actuating, keys.

However, some advanced keyboard technologies fail to provide tactile feedback, which generally leads to poor typing efficiencies and user experience. For example, typists who use pressure sensitive keyboards can only feel their finger on the surface of the key, but cannot feel any movement of the key, causing them to mistype, or else resort to visual feedback by checking finger placement.

Furthermore, despite the aforementioned advancements in hardware technology for keyboards, corresponding advancements in keyboard software are lacking. For example, many computing devices still use device stacks (e.g., drivers and kernel-mode programs) that simply report which keys have been pressed via scan codes. As a consequence, users continue to type on keyboards with advanced hardware designs with poor efficiency and accuracy.

### SUMMARY

Described herein are techniques and systems for obtaining contextual information, at least a portion of which may be received from keyboards or similar human interface devices (HIDs), to improve typing efficiencies and user experience. Contextual (or “rich”) information, as used herein, may include keyboard attributes, typing metadata, user actions, and the like, which will be described in more detail below. Furthermore, contextual information may be “real-time” information that is associated with an input event, and/or “non-real-time” information that may be received by the system at any point in time (e.g., before, during or after an event).

In some embodiments, a system comprises a keyboard that is configured to detect an input event at the keyboard. The system may further comprise a human interface device (HID) stack maintained in one or more memories of the system to receive contextual information, and a keyboard manager maintained in the one or more memories and executable on one or more processors to determine an output based at least in part on the input event and the contextual information.

In some embodiments, a process of obtaining contextual information from a keyboard to improve typing efficiencies includes detecting, via one or more sensors, an input event received at the keyboard, receiving contextual information, and determining, via one or more processors, an output based at least in part on the input event and the contextual information.

The systems and techniques described herein support obtaining rich, contextual information from keyboards and similar HIDs via an HID stack at least partly in kernel space that is in direct interaction with the keyboard and associated hardware. By implementing receipt and provisioning of the rich, contextual information in the HID stack, the contextual information can be standardized via the HID stack, which drives a standard class of HIDs (e.g., keyboards, mice, etc.), and ultimately leveraged by multiple different user processes and applications in the user space. These systems and techniques will further improve typing efficiency and user experience by enabling the system to deduce user intent, which may be used for prediction algorithms, automatic correction and suggestion features, among other things.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates an exemplary computing system environment comprising a computing device configured to obtain contextual information.

FIG. 2 illustrates an exemplary keyboard to provide contextual information to components of an associated computing device.

FIG. 3 illustrates an example computing system to implement a human interface device (HID) stack configured to receive contextual information from a keyboard, and to send this contextual information to other components of the system.

FIG. 4 is a flow diagram of an illustrative process for receiving contextual information, and determining a most probable output based on an input event and the contextual information.

FIG. 5 is a flow diagram of an illustrative process for processing contextual information, and performing real-time correction and/or suggestion actions.

### DETAILED DESCRIPTION

Embodiments of the present disclosure are directed to, among other things, techniques and systems for obtaining contextual information, at least a portion of which may be received from a keyboard, to improve typing efficiencies and user experience. Embodiments disclosed herein may be applied to keyboards, or similar human interface devices (HIDs), that may contain one or more keys or buttons. Keyboards, as used herein, may be physical keyboards (i.e., made of a tangible material with a physical structure) integrated with, or used as a peripheral device to, computing devices. Physical keyboards may be of any structure with structure and thickness ranging from a sheet of paper to a keyboard with mechanically movable key-switch structures. For example, keyboards used with slate or tablet computers (e.g., the Touch Cover™ used with the Surface™ tablet manufactured by Microsoft® Corporation of Redmond, Wash.), notebooks or laptop computers, and the like, are contemplated for use with the embodiments of the present disclosure. However, it is to be appreciated that the disclosed embodiments may also be utilized with other similar types of HIDs (i.e., HIDs having multiple keys) and non-physical keyboards, including, but not limited to, virtual keyboards (e.g., laser-based keyboards projected onto an existing surface such as a table top), pointing devices with keys or buttons, joysticks, remote control input devices for television or similar devices, gaming system controllers, mobile phones keyboards, automotive user input mechanisms, home automation (e.g., keyboards embedded in furniture, walls, etc.), and the like. The term “external keyboard” is sometimes used herein to denote any keyboard, including those listed above, that may be removably coupled to (wired or wireless), or permanently embedded within, an associated computing device, not including on-screen, or soft, keyboards that display a keyboard graphical user interface (GUI) on an output display screen of a computing device.

The techniques and systems disclosed herein utilize an advanced HID stack without space constraints in that the HID stack is configured to receive and process a large amount of contextual information received from an associated keyboard in a standardized implementation that may be leveraged by multiple different user processes. A keyboard manager, as described herein, may utilize the contextual information provided from the HID stack in a variety of ways, such as to deduce an intended output, such as a non-text-based output (e.g., a function), or a text-based output (e.g., character or word output).

The techniques and systems described herein may be implemented in a number of ways. Example implementations are provided below with reference to the following figures.

### Example Computing System

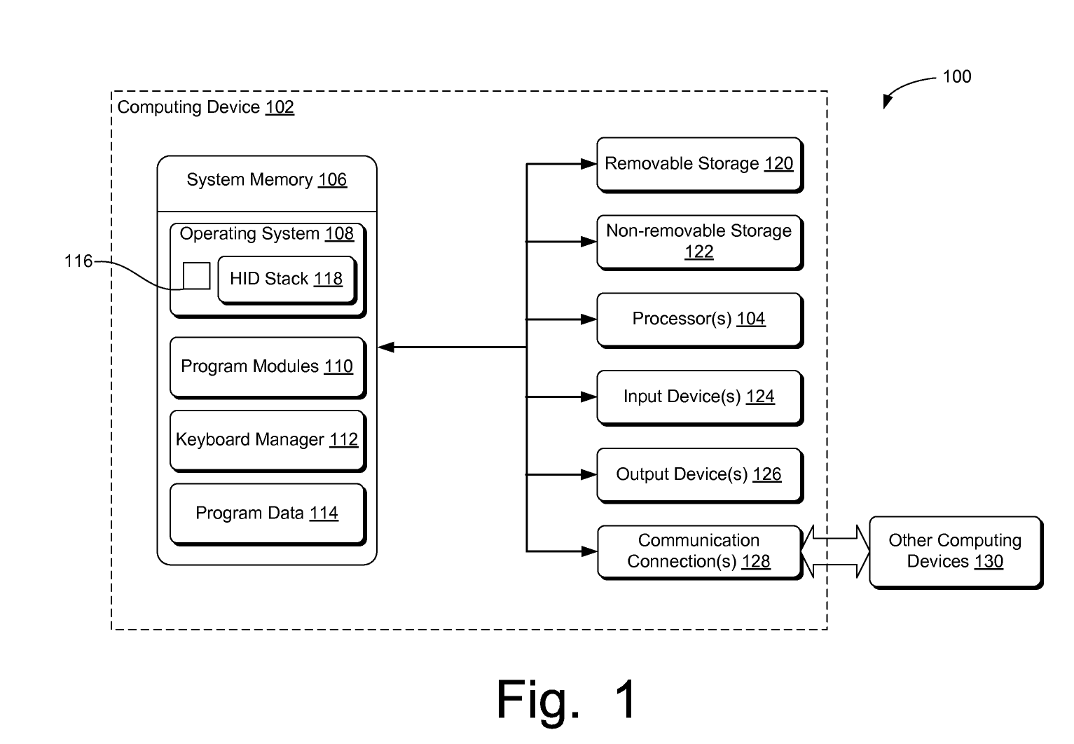

FIG. 1 illustrates an exemplary computing system environment 100 comprising a computing device 102 that is configured to obtain contextual information from a keyboard associated with the computing device 102. For example, the computing device 102 may be a tablet or notebook computer configured to accept input data from the keyboard.

In some embodiments, the computing device 102 includes one or more processors 104 and system memory 106. Depending on the exact configuration and type of computing device, the system memory 106 may be volatile (e.g., random access memory (RAM)), non-volatile (e.g., read only memory (ROM), flash memory, etc.), or some combination of the two. The system memory 106 may include an operating system 108, one or more program modules 110 or application programs, a keyboard manager 112, and program data 114 accessible to the processor(s) 104. As will be described in more detail, below, the keyboard manager 112 is configured to receive contextual information originating from a keyboard associated with the computing device 102, and to use the contextual information in a variety of ways, such as issuing real-time suggestion/correction features to text data. The operating system 108 may include a component-based framework 116 that supports components (including properties and events), objects, inheritance, polymorphism, reflection, and provides an object-oriented component-based application programming interface (API), such as that of the Win32™ programming model and the .NET™ Framework manufactured by Microsoft® Corporation of Redmond, Wash. The operating system 108 may further include a human interface device (HID) stack 118 that is configured to receive contextual information directly from the keyboard and provide the contextual information to other components of the system, such as the keyboard manager 112. The HID stack 118, at a general level, is configured to drive a standard class of HIDs (e.g., keyboards, mice, etc.), and the HID stack 118 may run, at least partly, in kernel space of the computing device 102, which is denoted by virtue of the implementation within the operating system 108. However, it is to be appreciated that at least a portion of the HID stack 118 may run in the user space of the computing device 102. Furthermore, the HID stack 118 may include mappings between contextual information and likely output that may be leveraged by other components of the system for deducing user intent. The HID stack 118 may be configured to standardize the contextual information such that multiple different user-mode processes may process the contextual information in a variety of ways.

The computing device 102 may also include additional data storage devices (removable and/or non-removable) such as, for example, magnetic disks, optical disks, or tape. Such additional storage is illustrated in FIG. 1 by removable storage 120 and non-removable storage 122. Computer-readable media, as used herein, may include, at least, two types of computer-readable media, namely computer storage media and communication media. Computer storage media may include volatile and nonvolatile, removable and non-removable media implemented in any method or technology for storage of information, such as computer readable instructions, data structures, program modules, or other data. The system memory 106, removable storage 120 and non-removable storage 122 are all examples of computer storage media. Computer storage media includes, but is not limited to, RAM, ROM, electrically erasable programmable read-only memory (EEPROM), flash memory or other memory technology, compact disk read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the computing device 102. Any such computer storage media may be part of the device 102.

In some embodiments, any or all of the system memory 106, removable storage 120 and non-removable storage 122 may store programming instructions, data structures, program modules and other data, which, when executed by the processor(s) 104, implement some or all of the processes described herein.

In contrast, communication media may embody computer-readable instructions, data structures, program modules, or other data in a modulated data signal, such as a carrier wave, or other transmission mechanism. As defined herein, computer storage media does not include communication media.

The computing device 102 may also comprise input device(s) 124 such as a touch screen, keyboard, pointing devices (e.g., mouse, touch pad, joystick, etc.), pen, microphone, etc., through which a user may enter commands and information into the computing device 102. Although the input device(s) 124 are shown in FIG. 1 to be within the computing device 102, it is to be appreciated that the input device(s) 124 may be physically embedded within the computing device 102 (e.g., an embedded keyboard or touch screen), or the input device(s) 124 may be peripheral devices that are removably coupled to the computing device 102 through either a wired or wireless connection. In the context of HIDs (a subset of possible input device(s) 124), and specifically in the context of keyboards, both physically embedded and removably coupled keyboards are considered to be “external keyboards,” as the term is used herein, as distinguished from on-screen, soft keyboards, as described above. The input device(s) 124 may be coupled to the processor(s) 104 through a wired user input interface, such as a universal serial bus (USB) interface, or a wireless user input interface such as WiFi or Bluetooth®. Output device(s) 126, such as a display, speakers, a printer, etc., may also be included as part of, or coupled to, the computing device 102.

The computing device 102 may operate in a networked environment and, as such, the computing device 102 may further include communication connections 128 that allow the device to communicate with other computing devices 130, such as over a network. The communication connections 128 are usable to transmit communication media, for example. Communication media may be embodied by computer readable instructions, data structures, program modules, etc.

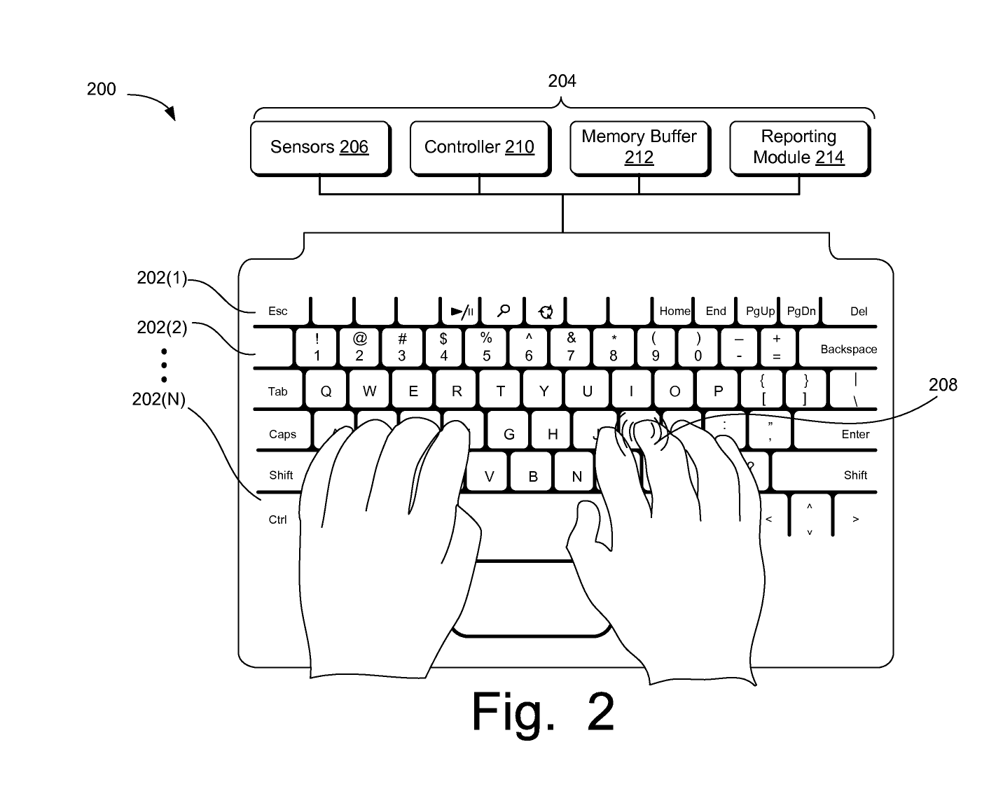

FIG. 2 illustrates an example keyboard 200 to be used in the embodiments disclosed herein for providing contextual information to components of an associated computing device, such as the computing device 102 of FIG. 1. The keyboard 200 is one example of an input device 124 of FIG. 1 that may be either embedded within a computing device, or removably coupled to the computing device 102, as with a peripheral keyboard. As such, the keyboard 200 may be considered an “external” keyboard. The keyboard 200 may be physically connected to such a computing device through electrical couplings such as wires, pins, connectors, etc., or the keyboard 200 may be wirelessly coupled to the computing device, such as via short-wave radio frequency (e.g., Bluetooth®), or another suitable wireless communication protocol. Furthermore, although the embodiments disclosed herein are described primarily with respect to “physical” keyboards, other similar HIDs having one or more keys or buttons, as well as other keyboard technologies, such as virtual keyboards that use a laser to project a keyboard layout on a flat surface and optical sensors to detect input events and other information, may be used without changing the basic characteristics of the system. Any keyboard that is “external” to an associated computing device in the sense that it is not an on-screen, soft keyboard that displays a keyboard GUI on an output display screen of a computing device, is contemplated for use with the embodiments disclosed herein, whether it be a physical or virtual keyboard.

The keyboard 200 may include a plurality of individual keys 202(1), 202(2), . . . , 202(N), or buttons, that are provided in an arrangement or layout to enable human input. The keyboard 200 of FIG. 2 illustrates one example layout, but it is to be appreciated that the embodiments disclosed herein are not limited to any particular keyboard layout such that keyboards with any number of keys 202(1)-(N) in any arrangement or layout may be utilized without changing the basic characteristics of the system. The keys 202(1)-(N) may be actuating, or non-actuating, physical, or virtual, and each key 202(1)-(N) may be appropriately labeled to identify a particular key with one or more characters, such as letters, numbers, symbols, etc. The keys 202(1)-(N) may generally register a specific character, symbol, or function upon activation of the keys 202(1)-(N) which may be determined from a detected input event, as described below.

The keyboard 200 generally includes associated keyboard components 204 that are configured to sense/detect finger placement or otherwise detect and register a key activation, such as key-press or a touch of, or proximity to, a key 202, analyze the input data, and send the data to components of an associated computing device, such as the computing device 102 of FIG. 1. These keyboard components 204 may be hardware and/or software components, and may be internal components of the keyboard 200, as is the case with most physical keyboards, or they may be external to, and communicatively coupled to the keyboard 200, as is the case with a virtual keyboard, for instance. Accordingly, the keyboard components 204 may comprise sensors 206 to detect x-y coordinates of a user's finger 208, or a similar object (e.g., stylus, pen, pointer, etc.). This detection by the sensors 206 may be considered an “input event.” Such an input event may be a physical touch event (e.g., finger 208 touching a surface of the keyboard 200), or it may be a proximity event, such as hovering one's finger above a surface of the keyboard 200 in close proximity thereto. In the proximity input scenario, the sensors 206 may include proximity sensors based on any suitable proximity sensing technology (e.g., capacitive, infrared, inductive, etc.). In some embodiments, the sensors 206 may include contacts in an electrical switch matrix, capacitive-based sensors, hall-effect sensors, optical-based sensors, pressure sensors (e.g., force-sense resistors), or any suitable sensor to detect finger placement in an x-y coordinate plane of the keyboard 200 and/or associated keys 202(1)-(N) that have been pressed upon by a human finger 208 or other object, such as a pen, stylus, pointer, etc. The sensors 206 may be further configured to detect additional information to that of finger placement, such as an amount of pressure applied by the finger 208, or similar object, a size or shape of the contact point, a duration of the input event (e.g., how long the finger/object touches or hovers at a location on the keyboard 200. As one illustrative example, when pressure sensors are utilized, the sensors 206 may register a key-press upon detecting that an applied pressure meets or exceeds a threshold pressure to register a key-press. Utilizing a threshold to trigger a key-press allows for a user to rest his/her fingers on the keyboard 200 utilizing pressure sensors with non-actuating keys so that an unwanted key-press is not registered.

The keyboard components 204 may further include a keyboard controller 210 configured to monitor input data detected by the sensors 206, analyze the data and forward the data to the operating system 108 of the computing device 102. The analysis by the controller 210 may be to determine what characters, among other information, to send to the operating system 108 of the computing device 102. The controller 210 may be an integrated circuit (IC) that processes the data received from the sensors 206. In some embodiments, a memory buffer 212 may be included among the keyboard components 204 in order to maintain input data before it is sent to the operating system 108.

In some embodiments, the keyboard components 204 may further include other components between or alongside the keyboard 200 and the computing device 102. Presence or absence of such components vary among embodiments, and these other components may add additional contextual information such as timing information (e.g., a current date and/or time) or information about additional environmental factors that can be combined with the contextual information from the keyboard 200 to assist the computing device 102 in its input processing tasks.

In some embodiments, the keyboard components 204 further include a reporting module 214 configured to report keyboard attributes (a subset of contextual information), or HID attributes in the context of a similar HID, to an associated computing device, such as when the keyboard 200 is initially coupled to the computing device, or at another suitable time, such as periodically at predetermined intervals or upon a suitable event. The keyboard attributes that may be reported by the reporting module 214 may be the keyboard type (e.g., pressure sensitive, optical-based, virtual laser-based, etc.), language (e.g., English, French, Chinese, etc.) of the keyboard characters, the layout of the keyboard 200 including a referential x-y coordinate plane, adjacency relationships (i.e., which keys 202(1)-(N) are proximate to, or otherwise in the vicinity of, other keys 202(1)-(N), the dimensions (e.g., length, width, thickness, etc.) of the keyboard 200, size of the keys 202(1)-(N), spacing of the keys 202(1)-(N) (e.g., distance between keys, pitch, etc.), travel distance that the keys 202(1)-(N) move when pressed or actuated, and similar attributes. Such keyboard attributes are just some examples of the “contextual information” that may be provided by the keyboard 200 and utilized by the embodiments disclosed herein, as will be described in more detail below.

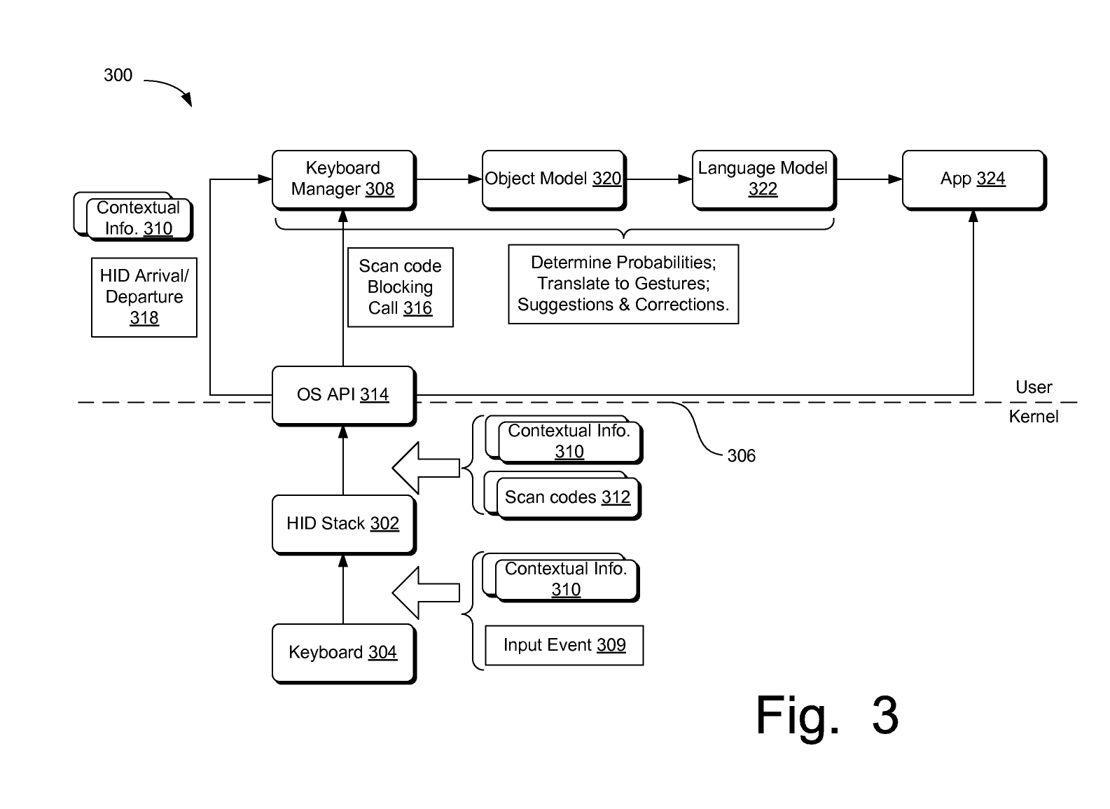

FIG. 3 illustrates an example computing system 300 to implement an HID stack 302 configured to receive contextual information from a keyboard 304, and to send this contextual information to other components of the system 300. Although FIG. 3 shows a keyboard 304, it is to be appreciated that the example computing system may be implemented with other similar types of HIDs having one or more keys or buttons (e.g., joysticks, remote controls, game controllers, etc.) without changing the basic characteristics of the system 300. Line 306 separates the components of the system 300 such that the components that generally execute in the operating kernel of a host computing device are shown below line 306, while components that execute in user mode applications are shown above line 306. For example, the HID stack 302, which may include drivers capable of driving a standard class of HIDs (e.g., keyboards, mice, etc.), runs at least partly in kernel mode (FIG. 3 shows an example where HID stack 302 is entirely in kernel mode), while a keyboard manager 308 is shown as running in the user mode in FIG. 3. Kernel mode refers to a mode of operation of a computer in which the software program presently being executed is permitted to execute the full instruction set of the processor, access all parts of the computer's memory and interact directly with hardware devices attached to a computer. Kernel-mode is typically restricted to software modules that form part of the operating system 108 of the computing device 102. Failures of a kernel-mode process can result in the operating system 108 crashing and/or corrupt memory for other processes.

User mode refers to a mode of operation in which the software program presently being executed is not permitted to execute a subset of instructions deemed privileged in the design of the computer's central processing unit (CPU), may only access a subset of the computer's memory that has been specifically allocated to the program, and may only access other parts of memory and attached hardware devices through the mediation of kernel mode software typically running as part of the operating system 108. Because a user mode process has process separation between it and other user mode processes enforced by the operating system 108, if a user mode process fails/crashes, this does not, in general, crash other user mode or operating system processes. A user mode module is typically written at a higher-level language than that of the kernel mode modules.

In general the components of the computing system 300 of FIG. 3 represent a combination of hardware and software components and the flow of data between each. As a user places his/her finger 208, or similar object, on or near the keyboard 304 in the x-y plane of the keyboard 304 (or keyboard 200 of FIG. 2), the keyboard 304 detects this placement as an input event 309 and sends the input event 309 and contextual information 310 to the HID stack 302. The contextual information 310 may include information that can be classified generally into five types: (1) keyboard attributes, (2) typing metadata, (3) user actions, (4) user data, and (5) environmental data.

Keyboard attributes were mentioned previously and may include various attributes of the keyboard 200, 304 such as the keyboard type (e.g., pressure sensitive, optical-based, virtual laser-based, etc.), language (e.g., English, French, Chinese, etc.) of the keyboard characters, printed labels on each of the keys 202(1)-(N), the layout of the keyboard 200 including a referential x-y coordinate plane, adjacency relationships (i.e., which keys 202(1)-(N) are proximate to, or otherwise in the vicinity of, other keys 202(1)-(N), the dimensions (e.g., length, width, thickness, etc.) of the keyboard 200, size of the keys 202(1)-(N), spacing of the keys 202(1)-(N) (e.g., distance between keys, pitch, etc.), travel distance that the keys 202(1)-(N) move when pressed or actuated, and similar attributes. In addition, as was mentioned previously, the keyboard attributes may be sent from the keyboard 304 to the HID stack 302 at any suitable time, such as upon coupling the keyboard 200, 304 to an associated computing device 102, periodically, upon detection of an input event.

The subset of contextual information 310 classified as typing metadata may include information such as the x-y coordinate position of a user's finger 208, or similar object, when placed on or near the keyboard 200, or when a key-activation event is detected by at least one of the sensors 206, shape and/or size of the contact point between the surface of the keyboard 200 (or surface on which the keyboard is projected) and the user's finger 208, duration of the input event, and similar metadata that may be detected or determined in the context of a typing event like a key-activation. In some embodiments, the typing metadata may further include probability or confidence data, which indicates a likelihood that a key activation or key press registered by an input event at the keyboard 200 was a “correct” key, and may possibly include alternate candidate keys that it determines to have a high probability of being intended keys.

The third subset of contextual information 310 classified as user actions may include information such as finger movements, swipes (e.g., sequentially detected coordinate positions of a user's finger 208, or similar object), or other gestures, application of increased pressure, and the like, that may be imparted on the keyboard 200 by the user's finger 208, multiple of the user's fingers, and/or a similar object(s). User actions, as used herein, denote actions by the user other than traditional typing actions that involve merely touching or depressing a key 202. By contrast, user actions involve some supplementary finger movement to impart a gestural function. As is described below, the disclosed system's ability to detect and process user actions as a form of contextual information 310 enables a variety of downstream features to be implemented that facilitate improved typing efficiency and user experience.

The fourth subset of contextual information 310 classified as user data may include any suitable information pertaining to a particular user who may be operating the computing device 102 and keyboard 200. This type of contextual information 310 may be provided by a component of the system 300 other than the keyboard 200, such as via login information in the system 300 to know that a particular user is logged in. The user data may further include profile data and historical data about the user, such as different preferences, common mistakes, typing styles, hand size, typing intensity, and the like. The system 300 can therefore apply different algorithms tailored to the particular user when interpreting an input event from the keyboard 200.

Lastly, the subset of contextual information 310 classified as environmental data may include timing information such as a global time or a time according to a specific time zone, and other environmental information. This information may also be provided by components external to the keyboard 200, although it is contemplated that the components 204 may include suitable internal clocks or other components to obtain environmental data. As such, the environmental data may or may not be provided by the keyboard 200 in some embodiments.

Continuing with reference to FIG. 3, the HID stack 302 is configured to receive the input event 309 from the keyboard 304, and to receive the contextual information 310 from the keyboard 304 and/or another component alongside or between the keyboard 304 and the computing device 102, or embedded within system 300. The input event 309 may be interpreted by the HID stack 302 as at least one of a gesture or key activation/press, depending on the nature of the input event 309. In some embodiments, the HID stack 302 may receive at least a portion of the contextual information 310 from other components external to, alongside or between the keyboard 200 and the computing device 102. For example, some keyboard attributes may be known to the system 300 inherently, such as in a closed system. As another example, the aforementioned user data may be determined from the system 300 knowing that a particular user is logged into a user account for the device. Accordingly, at least some of the contextual information 310 may be provided by components other than components 204 of the keyboard or the keyboard 304 itself.

The HID stack 302 of the embodiments disclosed herein does not have the space constraints that are typical of conventional keyboard stacks, allowing the HID stack 302 to receive and manage the abundance and variety of contextual information 310 that may be provided by the keyboard 304 or another component, as described in detail above. The contextual information 310 may be standardized via the HID stack 302, and possibly mapped to likely output, allowing downstream components, user processes and/or applications to utilize the contextual information 310 in a variety of ways. The HID stack 302 may include drivers that are configured to drive a standard class of HIDs, such as the keyboard 304. The drivers may generally comprise software components configured to drive HIDs, and to convert input data received from the keyboard 304 into scan codes 312 for character input data that is sent to the downstream components of the system 300. It is to be appreciated, however, that implementations using scan codes 312 are purely optional, as other suitable HID processing techniques and implementations for determining and sending character input data are available that do not utilize scan codes, such as native HID processors. The HID stack 302 may comprise other suitable drivers (e.g., function drivers, device controller drivers, etc.) as needed for relaying input data received from the keyboard 304 to downstream components of the system 300. HID drivers are known to a person having ordinary skill in the art and therefore need not be described in detail herein.

The HID stack 302 may further provide the converted scan codes 312, or similar character input data, and the received contextual information 310 to an operating system (OS) API 314. In some embodiments, the input data may be passed directly from the HID stack 302 to the OS API 314. The OS API 314 may be any suitable platform implementation, such as a Windows® API (e.g., Win32™ API) manufactured by Microsoft® Corporation of Redmond, Wash., Carbon™ or Cocoa™ APIs manufactured by Apple® Inc. of Cupertino, Calif. In general, the OS API 314 is configured to manage screen windows, messaging, and the like, and is responsible for routing key activation (e.g., “key-up” and/or “key-down”) messages to different user mode applications. The OS API 314 may optionally generate a scan code blocking call 316 when scan codes 312 are used, which it provides to the keyboard manager 308, and the OS API 314 may further generate one or more hotkeys, or shortcut keys, to send to the keyboard manager 308. The OS API 314 may be further configured to forward the contextual information 310, possibly along with additional information, such as HID arrival, or departure, notifications 318, to the keyboard manager 308 for further processing at the keyboard manager 308.

As shown in FIG. 3, the keyboard manager 308 is a user mode module configured to use the received contextual information 310 in a variety of ways. For instance, the keyboard manager 308 may analyze any subset of the received contextual information 310 to determine user intent in terms of a probability that the user intended to activate the key 202 that was registered by the x-y coordinate location of the user's finger 208, or similar object. In some embodiments, the keyboard manager 308 is further configured to identify neighboring keys (i.e., within a defined radius, near, or adjacent) to that of an activated key 202 of the keyboard 200, as determined from the adjacency information in the keyboard attributes, and the keyboard manager 308 may filter out unwanted/unintended keys 202(1)-(N) for determining a most probable output. In some instances, the probability determination for specific keys may take into account a previously detected key-activation in determining a probability of one or more neighboring keys to a currently activated key 202. For example, when a user initially activates the “Q” key with their finger 208, and subsequently presses the “Y” key, the keyboard manager 308 may utilize adjacency information in the keyboard attributes of the contextual information 310 to determine that it is probable that the user intended to press the “U” key. Since language of the keyboard characters is a form of typing metadata—a subset of contextual information 310—it is to be appreciated that other similar examples in languages other than English would provide similar results.

In some embodiments, the keyboard manager 308 may work in conjunction with other user mode processes, such as an object model 320 and/or a language model 322. These components may contain information to deduce user intent, such as language dictionaries of words in various languages, and the like.

The keyboard manager 308 may be further configured to translate received user actions into gestures like gestures to zoom in/out, pan, rotate, activate a menu, etc. These gestures may be deduced from user action information that relates to movement of one or more of the user's fingers (e.g., rotation of two or more fingers, separation of two or more fingers, swiping, etc.). Pressure variations may also be imparted on the keyboard 200 by a user pressing his/her finger 208, or similar object, onto the keyboard 200 with greater force relative to an initial key-press. These pressure variations (i.e., increases/decreases) may impart a gestural function such as imparting bold-faced font, activating a menu, etc.

Furthermore, the keyboard manager 308, possibly in conjunction with the object model 320 and language model 322, may issue text suggestions and/or make character or word-based auto-corrections based on determined probabilities and language dictionaries. These actions may be based on per-character fuzzy targeting or similar techniques for quick insertion/suggestion of characters based on received contextual information 310. In some cases, auto-correction actions may include quick insertion of punctuation (e.g., a period), or bold font correction based upon received typing metadata such as increased pressure detection at a finger position, and the like. These suggestion/correction actions are, in some embodiments, “quick” suggestions/corrections to denote that they may be issued in real-time with an event, such as an input event (e.g., user finger 208 in proximity/touching/pressing upon the keyboard 200). In this fashion, the user may be provided with real-time, contemporaneous suggestion/correction features.

The system 300 may further include a user mode application 324 configured to receive output from the keyboard manager 308, possibly in conjunction with the object model 320 and language model 322, to utilize the received output in user mode application programs, such as word processing, or other similar programs that typically receive input from HIDs such as keyboards 200. In some embodiments, the output may be a most probable output based on the input event and the contextual information 310 and may include text-based output, editing actions (e.g., deletions, etc.), insertion point navigation (e.g., navigating where data or functions will be placed or enacted when entered), application control, or any keyboard function. The system 300 allows for contextually enhanced processing of all keyboard functions.

### Example Processes

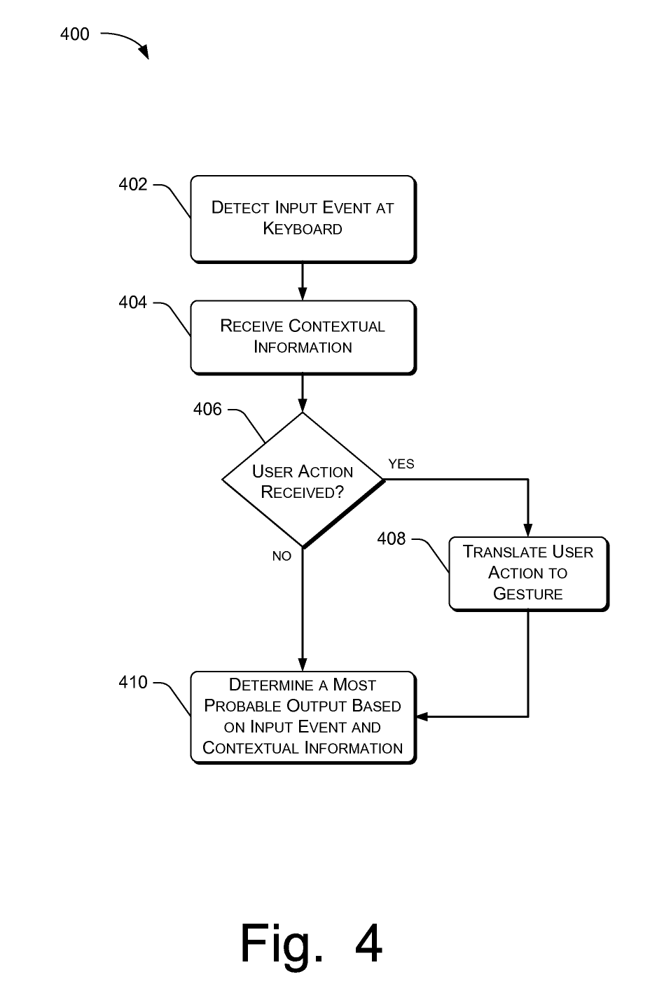

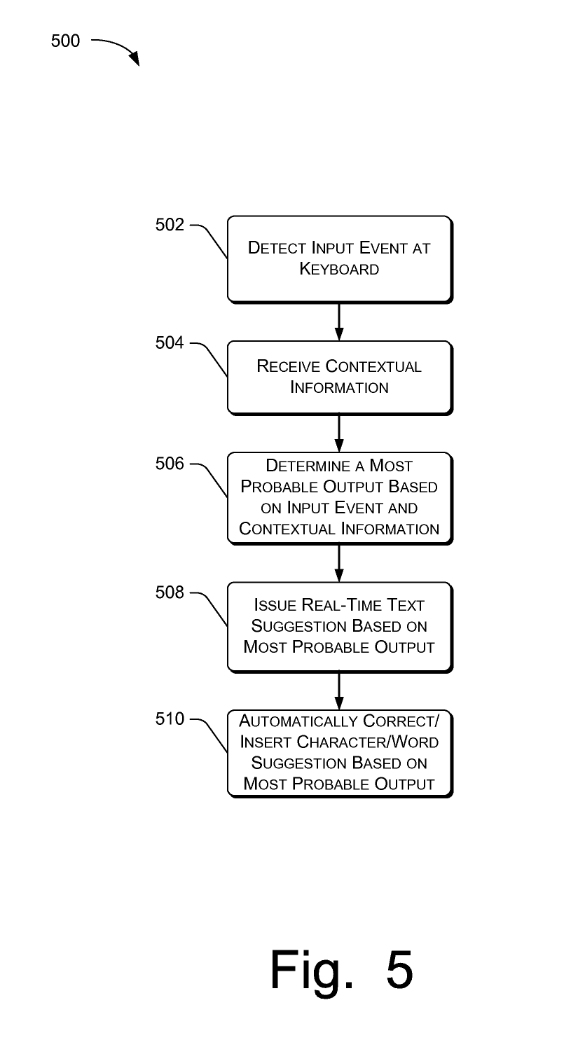

FIGS. 4 and 5 illustrate processes as a collection of blocks in a logical flow graph, which represents a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 4 is a flow diagram of an illustrative process 400 for receiving contextual information from a keyboard, and determining a most probable output based on an input event and the contextual information. For discussion purposes, the process 400 is described with reference to the computing system environment 100 of FIG. 1, keyboard 200 of FIG. 2, and the computing system implementation 300 of FIG. 3. Specifically the process 400 is described with reference to the HID stack 118, 302 and the keyboard manager 112, 308 of FIGS. 1 and 3.

At 402, an input event that is received at the keyboard 200 is detected via one or more of the sensors 206 associated with the keyboard 200. In some embodiments, the sensors 206 work in conjunction with an application specific integrated circuit (ASIC), system on chip (SoC), or similar IC to enable the detection at 402. For example, pressure sensors of a physical keyboard may work in conjunction with the keyboard controller 210 to detect an input event by detecting that an applied pressure on the surface of the keyboard 200 meets or exceeds a threshold pressure. It is to be appreciated that other sensor types and detection techniques are contemplated herein, such as by detecting an input event on an x-y coordinate plane of the keyboard 200 with a sensor 206 such as an optical sensor, capacitive sensor, or another suitable sensor type. In some cases, the input event can be associated with a particular key 202 on the keyboard 200. In other cases, the input event may detect a finger position of a user's finger 208 on the x-y coordinate plane which may overlap multiple keys 202(1)-(N) on the keyboard 200.

At 404, the HID stack 118, 302 may receive contextual information 310 from the keyboard 200, or another component of the computing device 102. As described above, the contextual information 310 may include any of keyboard attributes, typing metadata, user actions, user data, environmental data, or a combination of any of these. The HID stack 118, 302 is specifically configured to receive a large amount and variety of contextual information 310, unlike traditional keyboard stacks with constraints on the amount and types of information that may be received from external keyboards. The contextual information 310 may be standardized and provided to downstream components of the system which can receive and utilize the contextual information 310 in a standard implementation for a variety of purposes.

At 406, a determination may be made as to whether a user action (e.g., finger movement, swipe, increased applied pressure, etc.) is received in the contextual information 310. If it is determined at 406 that a user action is received at the HID stack 118, 302, the process 400 may proceed to 408 where the user action is translated to a gesture (e.g., zoom in/out, pan, impart bold font on character, etc.) by the keyboard manager 112, 308.

If it is determined at 406 that the contextual information 310 does not include a user action, or after, or contemporaneously with, the translation of the user action to a gesture at 408, the keyboard manager 112, 308 may determine a most probable output at 410 based on the input event and the contextual information 310. In some embodiments, the most probable output comprises an intended text output, such as an intended character or word the user is trying to type with the keyboard 200. As one illustrative example, the keyboard manager 112, 308 may determine at 410 that the user intends to type the letter “U” based on the input event of the keyboard that registered the letter “Y” on the keyboard 200, which is adjacent to the “U” character. In this example, the keyboard manager 112, 308 may consider keyboard attributes such as keys that are neighbors to the letter “Y,” which may include at least the letters, “T” “G” “H” and “U,” as well as the numbers “6” and “7,” according to at least one traditional keyboard layout. The keyboard manager 112, 308 may consider only these neighboring letters that it received from the contextual information 310, and may further consider typing metadata such as a preceding input event that registered the letter “Q.” Using the language model 322, the keyboard manager 112, 308 may determine that the character with the highest probability according to English language words is the letter “U.” It is to be understood that this is but one illustrative example, and other types of contextual information 310 may be utilized in addition, or alternatively, to the aforementioned contextual information 310.

Furthermore, the most probable output may include other non-text-based output, such as editing actions (e.g., deletions, etc.), insertion point navigation, application control, or any suitable keyboard function.

FIG. 5 is a flow diagram of an illustrative process 500 for processing contextual information 310 received from a keyboard and performing real-time correction and/or suggestion actions. For discussion purposes, the process 500 is described with reference to the computing system environment 100 of FIG. 1, keyboard 200 of FIG. 2, and the computing system implementation 300 of FIG. 3. Specifically the process 500 is described with reference to the HID stack 118, 302 and the keyboard manager 112, 308 of FIGS. 1 and 3.

At 502, a input event that is received at the keyboard 200 is detected via one or more of the sensors 206 associated with the keyboard 200. This may be similar to the detection of the input event described with reference to 402 of the process 400.

At 504, the HID stack 118, 302 may receive contextual information 310 from the keyboard 200. As described above, the contextual information 310 may include any of keyboard attributes, typing metadata, user actions, user data, environmental data, or a combination of any of these.

At 506, the keyboard manager 112, 308 may determine a most probable output based on the input event and the contextual information 310. In some embodiments, the most probable output comprises an intended text output, such as a most probable character or word the user is trying to type with the keyboard 200.

At 508, the keyboard manager 112, 308 may issue a text suggestion for application data in real-time to the detection of the input event at 502. This text suggestion may be based on the most probable output determined at 506. For example, if it was determined at 506 that the user intended to type the character “U,” even though the character “Y” was registered by the input event, the keyboard manager 112, 308, perhaps with the help of the language model 322, may suggest one or more words that start with the letters “Qu,” such as “Quote” “Quotient” “Question”, etc. Additional context from the contextual information 310 and/or application data may be utilized in order to narrow the set of possible words to suggest to the user.

At 510, the keyboard manager 112, 308 may automatically correct application data or insert the output within the application data that was determined at 506, such as a character or word that was determined to be the most probable character or word that the user intended to type. The auto-correction at 510 may be performed as an alternative to the text suggestion at 508, or it may be performed in conjunction with the text suggestion. Furthermore, the auto-correction at 510 may be based on a character, or on a word, such that it may correct either a character or a word. In some embodiments, the auto-correction applies to punctuation such as periods, semicolons, etc.

The environment and individual elements described herein may of course include many other logical, programmatic, and physical components, of which those shown in the accompanying figures are merely examples that are related to the discussion herein.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
detecting, via one or more sensors, an input event received at a human interface device (HID) comprising multiple keys;
obtaining contextual information, the contextual information including at least one of HID attributes, typing metadata or a user action; and
determining, via one or more processors, an output based at least in part on the input event and the contextual information.

2. The method of claim 1, wherein the HID comprises a keyboard and the HID attributes comprise keyboard attributes.

3. The method of claim 2, wherein the obtaining the contextual information comprises receiving the keyboard attributes, and wherein the keyboard attributes comprise at least one of a layout of the keyboard, a language of the keyboard, printed labels on the multiple keys, a keyboard type, dimensions of the keyboard, key spacing, key size, or neighboring key information.

4. The method of claim 2, wherein the output comprises a function, character or symbol of one of the multiple keys of the keyboard, and wherein the determining the output comprises determining a probability that a user intended to input the function, character or symbol based at least in part on the contextual information.

5. The method of claim 1, wherein the detecting the input event comprises detecting that an input pressure meets or exceeds a threshold pressure for registering the input event as a key-press.

6. The method of claim 1, wherein the obtaining the contextual information comprises receiving the typing metadata from the HID, the typing metadata including at least one of a coordinate position of the input event on a plane of an input surface of the HID, a shape associated with the input event, a size associated with the input event, or a duration of the input event.

7. The method of claim 1, wherein the obtaining the contextual information comprises receiving the user action, the user action being based at least in part on the input event and comprising at least one of a finger swipe of sequentially detected coordinate positions, rotation of multiple fingers, separation of multiple fingers, or application of increased pressure at the HID.

8. The method of claim 7, further comprising translating the received user action into a gesture comprising at least one of zooming, panning, rotation, activating a menu item, or navigating to an insertion point.

9. The method of claim 1, wherein the output comprises a character or a word, the method further comprising suggesting the character or the word in real time with the detecting the input event, or automatically correcting or inserting the character or the word within application data.

10. The method of claim 2, wherein the obtaining the contextual information comprises receiving the keyboard attributes, the keyboard attributes comprising neighboring key information, the method further comprising:
determining the output by identifying neighboring keys to a location of the input event; and
eliminating a subset of the multiple keys that are not the identified neighboring keys from consideration of the output.

11. A system comprising:
a keyboard having a plurality of keys configured to receive tactile input and detect an input event at the keyboard via one or more sensors;
one or more processors; and
one or more memories comprising:
a device stack to receive contextual information, the contextual information including at least one of keyboard attributes, typing metadata or a user action; and
a keyboard manager executable by the one or more processors to determine an output based at least in part on the input event and the contextual information.

12. The system of claim 11, wherein the keyboard manager is configured to determine the output by determining a probability of the output that is a function of the input event and the typing metadata including a preceding output.

13. The system of claim 11, wherein the contextual information includes the user action, and wherein the keyboard manager is configured to translate the user action to a gesture.

14. The system of claim 13, wherein the user action comprises at least one of a finger swipe, rotation of multiple fingers, separation of multiple fingers, or application of increased pressure at the keyboard.

15. The system of claim 11, wherein the keyboard further comprises sensors to detect the input event as a touch event, the touch event comprising placement of a user's finger on a surface of the keyboard.

16. The system of claim 15, wherein the contextual information includes the typing metadata, the typing metadata comprising a coordinate location of the user's finger relative to a referential coordinate plane of the keyboard.

17. The system of claim 11, wherein the keyboard further comprises a reporting module to report the keyboard attributes to the system, the keyboard attributes comprising at least one of a layout of the keyboard, a language of the keyboard, a keyboard type, dimensions of the keyboard, key spacing, key size, or adjacent key information.

18. The system of claim 11, wherein the output comprises a character or a word, and wherein the keyboard manager is further configured to suggest the character or the word in real time with the input event, or to automatically correct or insert the character or the word within application data.

19. The system of claim 11, wherein the device stack runs partly in a kernel space of the system and partly in a user space of the system, the device stack further comprising at least one driver for driving the keyboard upon coupling the keyboard to the system.

20. A method comprising:
detecting, via one or more sensors, an input event at a keyboard;
receiving contextual information, the contextual information including at least one of keyboard attributes, typing metadata or a user action; and
determining, via one or more processors, a most probable output based at least in part on the input event and the contextual information.
